(19) United States
(12) Patent Application Publication
(10) Pub. No.: US 2006/0051566 A1
(43) Pub. Date: Mar. 9, 2006

(54) Comfort element for clothing or an article of footwear, a method of manufacturing, and an article having such an element

(75) Inventor: Jean-Michel Challe, Rumilly (FR)

Correspondence Address: GREENBLUM & BERNSTEIN, P.L.C., 1950 ROLAND CLARKE PLACE, RESTON, VA, 20191, US

(73) Assignee: SALOMON S. A., Metz-Tessy (FR)

(21) Appl. No.: 11/143,443

(22) Filed: Jun. 3, 2005

(30) Foreign Application Priority Data
Jul. 26, 2004 (FR) 04.08249

(51) Int. Cl. B32B 37/00; B32B 3/26; B29C 65/00

(52) U.S. Cl. 428/304.4; 156/73.1

(57) ABSTRACT

A comfort element for an article of footwear or an article of clothing, a method of manufacturing same, and an article of footwear or clothing that includes such element. The comfort element is manufactured by superimposing a first layer of material having a melting temperature θ1, a layer of foam material having a melting temperature θ2, a second layer of material having a melting temperature θ3, the temperature θ2 being lower than θ1 and θ3, and assembling by welding the three layers to one another along predetermined welding lines, whereby the layer of foam material is brought to a temperature θ4 comprised between θ2 and θ1, θ3 along the welding lines. At least one film of heat-meltable glue, precut along the predetermined welding lines and having a melting temperature θ5 on the order of θ2, is inserted between one of the material layers and the foam material layer.

### CROSS-REFERENCE TO RELATED APPLICATION

This application is based upon French Patent Application No. 04.08249, filed Jul. 26, 2004, the disclosure of which is hereby incorporated by reference thereto in its entirety and the priority of which is hereby claimed under 35 U.S.C. 119.

### BACKGROUND OF THE INVENTION

1. Field of the Invention

The present invention relates to a comfort element for an article of clothing or footwear, as well as to an article of clothing or footwear having such a comfort element.

2. Description of Background and Relevant Information

Articles of footwear often have comfort elements that are either integrated directly into the upper of the article of footwear, or integrated into a generally unitary comfort liner, as is the case, for example, in an alpine ski boot or a snowboard boot.

Depending upon the type of footwear, such as a shoe or boot, such comfort elements are more or less necessary in the zones that are adapted to be in contact with sensitive zones of the foot, including but not limited to the instep zone, the heel zone, the zone of the malleoli in the ankle area, etc.

Some articles of clothing also have such comfort elements, for example, the thigh-pieces used in cycling, or protective elements such as knee pads, tibia protectors, etc., or articles adapted to be worn, such as safety harnesses or shoulder belts.

Generally speaking, the comfort elements used in such articles are constituted by foam/textile complexed assemblies in which the amount of comfort are more or less determined by stitches. These stitches are apparent and are therefore subject to wear and tear; they can also cause discomfort for the user. Furthermore, the manipulations associated with the stitching operations can negatively affect the reproducibility and quality of the comfort elements.

More recently, it has been proposed to form such elements from laminates, that is, composite materials combining a plurality of layers of foam, textiles glued to one another over their entire surfaces, which are shaped by thermoforming. Such elements are described in U.S. Pat. No. 6,670,029, for example.

The disadvantage of such a technology is that the layers of glue joining the various layers of the laminate can considerably affect the breatheability of the assembly.

Moreover, such a technology is not very flexible because the use of laminated textile materials suggests a large scale.

### SUMMARY OF THE INVENTION

An object of the present invention is to provide a new construction for comfort elements for articles of clothing and/or footwear.

In particular, an object of the invention is to provide comfort elements that are not subject to the drawbacks of the prior art.

Another object of the present invention is to provide a method of manufacturing comfort elements that is reproducible and compatible with small scale manufacturing.

Another object of the invention is to provide an improved comfort element.

The foregoing objects of the invention are achieved in a method of manufacturing a comfort element according to the invention, which includes superimposing:
a first layer of material having a melting temperature θ1;
a layer of foam material having a melting temperature θ2;
a second layer of material having a melting temperature θ3, the temperature θ2 being lower than temperatures θ1 and θ3;
   and assembling the three layers to one another along predetermined welding lines, by means of a welding operation bringing the layer of foam material to a temperature θ4 between temperature θ2 and temperatures θ1, θ3 along the welding lines.

The welding method used makes it possible to weld the two layers of material to one another by merely melting the foam layer, under the welding effect, which is then used as glue only along the predetermined welding lines of the welding electrode. As a result, the zones located between the welding lines, which are not pressed upon by the electrode, conserve their volume and provide a comfort element with the desired padded form/shape. According to one embodiment, the welding method used is a high-frequency welding method that enables a very fast welding, due to its deep penetration.

According to another feature of the invention, at least one film of heat-meltable glue, precut along the predetermined welding lines and having a melting temperature θ5 on the order of temperature θ2, is inserted between one of the textile material layers and the foam material layer. The addition of a heat-meltable glue film reinforces the gluing and, therefore, the stability of the comfort element, without negatively affecting the breatheability of the assembly since the glue film is precut along the welding lines of the electrode.

### BRIEF DESCRIPTION OF DRAWINGS

The invention will be better understood and other characteristics and advantages thereof will become apparent from the following description, with reference to the attached schematic drawings, in which:

FIG. 1 is an exploded perspective view of the various layers of the comfort element before assembly;

FIG. 2 is a bottom view of the finished comfort element;

FIG. 3 is a top view of the finished comfort element;

FIG. 4 is a perspective view with a portion broken-away, showing various possibilities of use of a comfort element according to the invention.

### DETAILED DESCRIPTION OF THE INVENTION

The comfort element 10, shown by way of a non-limiting example in the various drawing figures, is the tongue of a shoe. However, the invention encompasses comfort elements of various applications, particularly other comfort elements for the upper of an article of footwear, or a protective element for a thigh-piece, knee pad, tibia protector, etc., of various articles of clothing.

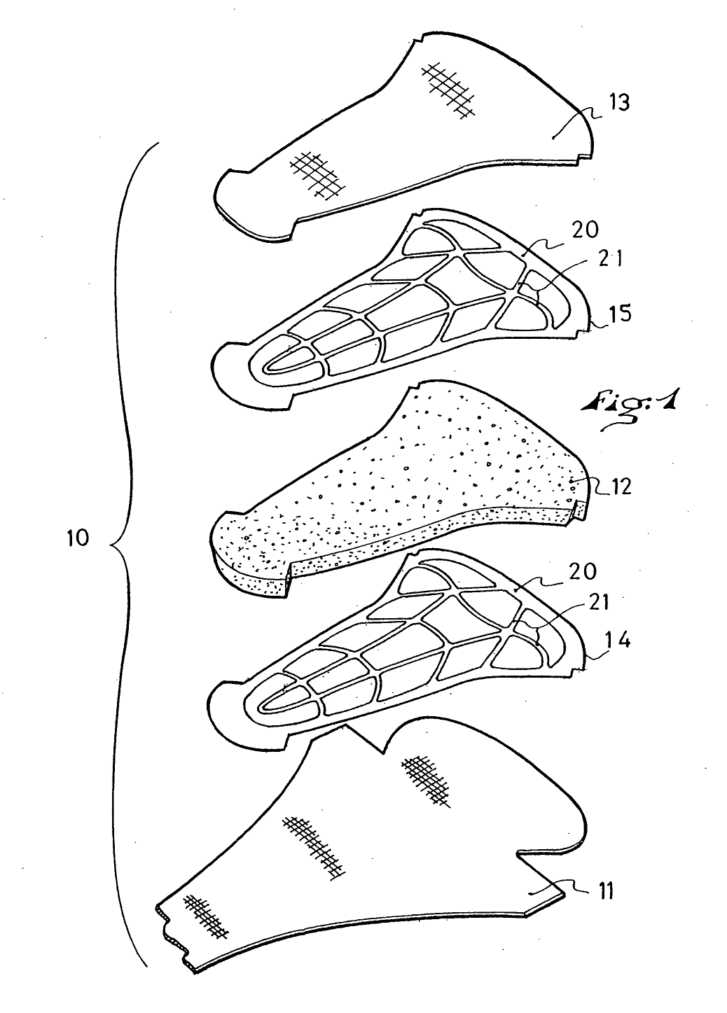

As shown particularly in FIG. 1, comfort element 10 comprises three primary layers, namely, a first outer layer 11, adapted to be turned outward relative to the article of footwear or garment, a foam material layer 12, and a second outer layer 13, the second outer layer being adapted to be turned inward of the article of footwear or garment. The two layers 11, 13 can be reversed if desired.

In a particular non-limiting embodiment, the first layer 11, as well as the second layer 13, is made of a textile material, such as a polyamide or polyester fabric, that is, a material having a relatively high melting temperature θ1, θ3, respectively, comprised in this case between 220° C. and 260° C., or between approximately 220° C. and approximately 260° C.

The foam layer 12 is a heat-meltable material, such as a polyurethane foam having a melting temperature θ2 lower than those θ1, θ3 of the first and second layers, respectively, and, in this case, on the order of 200° C. The foam layer could also be made of polyethylene, polypropylene, PVC or polystyrene.

Precut glue films 14, 15 can be inserted between the foam layer 12 and each of the first and second layers 11, 13, respectively. For example, the glue films 14, 15 can be polyurethane films having a melting temperature θ5 similar to that of the foam layer 12, or at least within the same range. Alternatively, other materials, such as polyethylene, polypropylene, PVC or polyamide, can be used.

When the glue films 14, 15 are used, they have a cut corresponding to that of the electrode of the high-frequency welding jaw (not shown in the drawing). This cut determines a perimetric edge 20 corresponding to the contour of the smallest textile material layer, in this case the second layer 13 in the example shown, as well as junction lines 21 that will define the welding zones or grooves of the finished comfort element.

The method of making the comfort element 10 is very simple. The various layers 11, 12, 13, are stacked in a pre-assembly, possibly with insertion of the glue layers 14, 15, and are arranged between the plate and the electrode of a high-frequency welding machine (not shown in the drawing).

The electrode has a cut similar to that of the glue films 14, 15 and, therefore, also has a perimetric edge and junction lines that are similar to the edge 20 and lines 21 of the glue films.

The electrode is lowered toward the plate so as to flatten or fully compress the foam layer 12 until the latter becomes very thin, on the order of 1/10^{th} of a millimeter.

A high-frequency electric field is then applied between the electrode and the plate. This field causes an internal heating of the matter arranged between the electrode and the plate up to a temperature θ4 on the order of 220° C., which is therefore higher than the melting temperature θ2 of the foam, while being lower than the melting temperatures θ1 and θ3 of the outer layers of the element in order not to damage their constituent materials, and, therefore, the foam layer in the area of the lines 20, 21 of the electrode is completely melted.

As it melts, the PU foam glues the outer fabric layers 11 and 13.

If PU glue films 14, 15 are inserted, they also melt, getting intermixed with the foam, and they complete the assembly between the two outer layers 11, 13.

Once the PU foam and the glue films have melted, the high-frequency electric field is interrupted, while the electrode is kept lowered so as to maintain pressure on the foam, until cooling off to a temperature that is lower than the melting temperature of the PU foam and on the order of 180° C.

The total cycle can be very short depending upon the materials used. In order to further optimize the duration of the cycle, the electrode and/or the plate can be preheated to a temperature on the order of 100° C. that does not damage the fabric layers 11, 13 or the PU foam layer.

By preheating the plate and the electrode, the total duration of the cycle can be reduced to several seconds.

The finished comfort element 10 is then in the form of a padded element, only having the thickness of the two outer layers 11 and 13 in the area of the welding lines 120, 121 corresponding to the lines with the cuts 20, 21, respectively, of the glue films or of the electrode, and having conserved almost the entire thickness of the foam layer between these lines.

This comfort element 10 is thus manufactured without stitching, and is therefore particularly comfortable to wear and less prone to wear and tear.

Moreover, the lack of or small amount of glue makes it possible to guarantee an optimum breatheability of such a comfort element, which is particularly appreciated for use in articles of footwear and/or articles of clothing.

The minimum addition of glue also makes it possible to reduce the weight and to provide the comfort element with a particularly optimal flexibility, since it does not have the stiffness effect associated with a conventional laminar/glued or laminated construction.

This manufacturing method is also compatible with the provision of an outer layer 11 that is impervious, or made impervious and/or breathable-impervious by the insertion of a PTFE film or a PU coating.

FIG. 4 shows the application of a comfort element according to the invention to various locations of a shoe.

In the example shown, the shoe 1 is a low-upper shoe, that is, it does not extend upward beyond the user's malleoli.

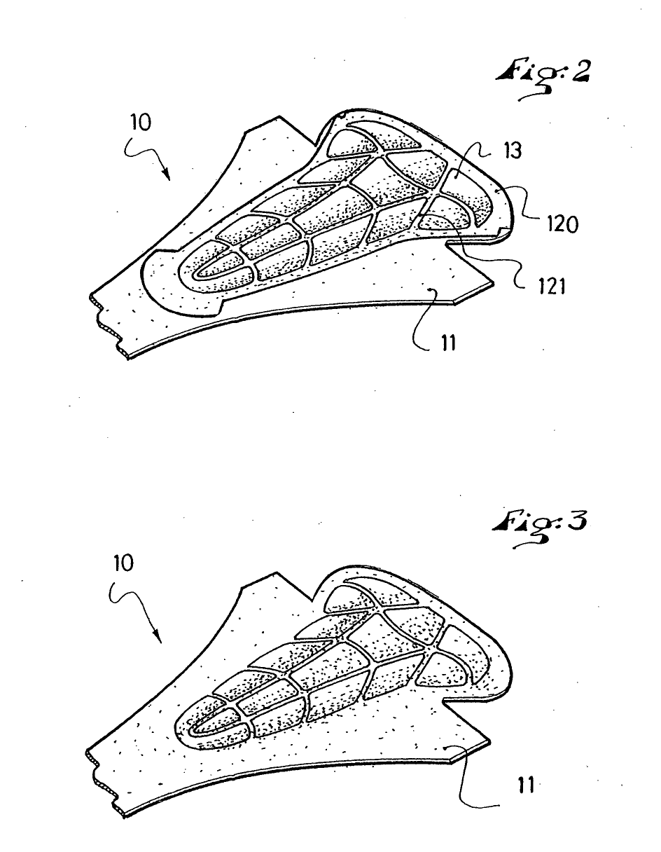

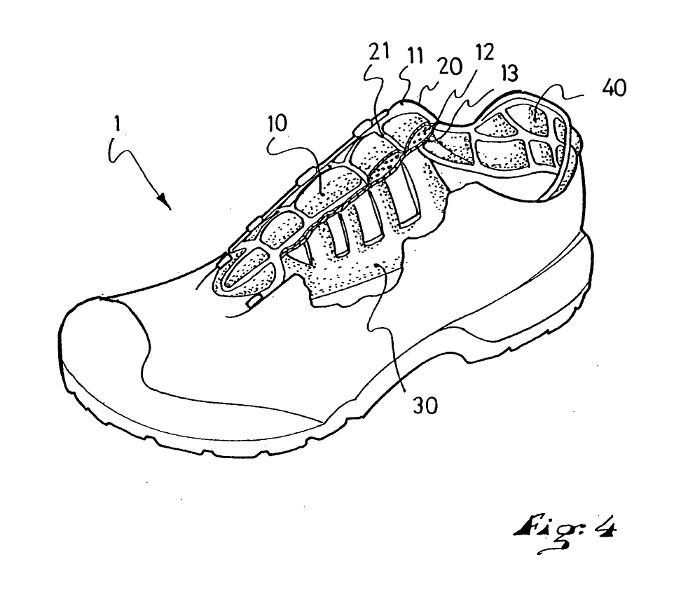

The shoe 1 has a tongue 10, a comfort element as previously described in connection with FIGS. 1-3. The tongue 10 is cut longitudinally and clearly shows the presence of the foam layer 12 in the zones outside of the welding or junction lines 21 and the lack of foam in the area of the junction lines 21.

Furthermore, the shoe 1 has a similar comfort element 30 in the area of its instep tightening zone and a comfort element 40 arranged at the rear, in the heel area.

The present invention is not limited to the embodiments described, but encompasses all similar and equivalent embodiments.

The invention applies to any type of comfort element used in high-upper or low-upper shoes and boots and to any type of clothing articles.

Furthermore, the invention is not limited to the use of the materials mentioned hereinabove by way of non-limiting examples, or to the type of welding described. Indeed, other welding methods can be envisioned insofar as they only locally heat the foam material. For example, thermal welding by means of a heating punch having an appropriate shape/cut can be used within the scope of the invention.

Moreover, this method can also be used to shape the comfort element simultaneously by using a lower tool (plate) that is non-planar but has an appropriate three-dimensional shape.

1. A method of manufacturing a comfort element for an article of footwear, said method comprising:
superimposing the following:
a first layer of material having a melting temperature θ1;
a layer of foam material having a melting temperature θ2;
a second layer of material having a melting temperature θ3, the temperature θ2 being lower than temperature θ1 and temperature θ3;
assembling by welding together the first layer, the layer of foam material, and the second layer along predetermined welding lines, said welding together bringing the layer of foam material to a temperature θ4 comprised between temperature θ2 and temperatures θ1, θ3 along said welding lines.

2. A method of manufacturing according to claim 1, wherein:
at least one film of heat-meltable glue, precut along the predetermined welding lines and having a melting temperature θ5 on the order of θ2, is inserted between one of the material layers and the layer of foam material.

3. A method of manufacturing according to claim 2, wherein:
the welding comprises using a welding machine having a welding electrode with a cut similar to that of the film of glue.

4. A method of manufacturing according to claim 1, wherein:
the welding is carried out under enough pressure to flatten the foam material layer.

5. A method of manufacturing according to claim 4, wherein:
pressure is maintained until the assembly cools off to a temperature lower than temperature θ2.

6. A method of manufacturing according to claim 1, wherein:
the welding comprises using a high-frequency welding machine.

7. A comfort element for an article of clothing or footwear, said comfort element comprising:
a first layer of material having a melting temperature θ1;
a layer of foam material having a melting temperature θ2;
a second layer of material having a melting temperature θ3, the temperature θ2 being lower than temperature θ1 and temperature θ3;
the three layers having been assembled together by a welding operation bringing the layer of foam material to a temperature θ4 comprised between θ2 and θ1, θ3 along predetermined welding lines.

8. A comfort element according to claim 7, wherein:
the first and second layers of material comprise polyamide or polyester fabric.

9. A comfort element according to claim 8, wherein:
one of the first and second layers is made of a material coated with a film or with a breathable-impermeable coating.

10. A comfort element according to claim 7, wherein:
the foam is PU foam.

11. A comfort element according to claim 9, wherein:
the film is a heat-meltable PU glue film.

12. A comfort element manufactured by the method according to claim 1.

13. An article of clothing comprising a comfort element according to claim 7.

14. An article of footwear comprising a comfort element according to claim 7.
